(19) United States
(12) Patent Application Publication
(10) Pub. No.: US 2023/0067006 A1
(43) Pub. Date: Mar. 2, 2023

(54) FLAT DC ELECTRIC MACHINE

(71) Applicant: Ramesh Chandra, Fremont, CA (US)

(72) Inventor: Ramesh Chandra, Fremont, CA (US)

(73) Assignee: Ramesh Chandra, Fremont, CA (US)

(21) Appl. No.: 17/874,231

(22) Filed: Jul. 26, 2022

Related U.S. Application Data
(60) Provisional application No. 63/226,144, filed on Jul. 27, 2021.

(51) Int. Cl. H02K 31/02; H02K 7/08; B60K 7/00; B60K 17/356

(52) U.S. Cl. CPC H02K 31/02; H02K 7/08; B60K 7/0007; B60K 17/356

(57) ABSTRACT

Various implementations of a dc electric machine based on interaction of radial currents with axial magnetic field are described herein. A set of mechanisms are described to implement the concepts resulting in flat dc electric motor/generator with or without brushes and no commutator. In a preferred embodiment of a dc electric machine, conventional brush is replaced with a roller type of mechanism to make electrical contacts. The dc electric machines described herein, use relatively low voltage power source for their operation. In preferred embodiments, axial magnetic field is generated by either a permanent disc magnet or electromagnet. The unique design described herein makes it possible to produce micro-motors either on a chip or a printed circuit board (PCB). Unique designs of a motorized wheel are described herein which helps implement a simpler but more capable Electric Vehicle (EV) and allows for frictionless braking system.

### RELATED U.S. APPLICATION DATA

Provisional Application No. 63/226,144, filed on Jul. 27, 2021

### FIELD OF THE INVENTION

The present invention is an axial flux dc disc or flat machine that uses electrical conductors in a special set of configurations that require no commutators and may not require any brushes.

### BACKGROUND

There exist several designs of axial flux motors such as disc, pancake, or flat motors. However, either they use commutators and or windings with alternate permanent magnet or electromagnet configurations. Most of them tend to have magnetic core. They tend to be similar to cylindrical dc motors in their basic design philosophy with either brushes and commutators or brushless with rotating or alternating magnetic fields achieved through either alternate positioning of different polarity of magnets or use electromagnets to achieve similar results.

The voltage needed to circulate current through these windings is usually significant for normal operation of the machines. These axial flux motors, even though significantly thinner than the cylindrical motors, can be made even thinner with better design concepts.

Cogging or torque ripple is virtually removed from pancake motors, resulting in smooth motion. However, such motors are limited in their power delivery and do not necessarily provide desirable torque speed curves for many applications. Their power to weight ration can be further improved.

### BRIEF SUMMARY OF THE INVENTION

Present invention of flat dc electric machine is based, in the preferred embodiments, on the interaction of radial currents with an axial magnetic flux. The production of these currents and axial magnetic fields depends on the application of the invention. This machine does not require any commutation and may not need a brush that would normally wear out due to friction and arcing. The design philosophy adopted here makes it possible to produce very thin efficient flat motors suitable for very smooth motion. These motors can be tailored for applications requiring micro-motors to electric motors suitable for electric vehicles.

### BRIEF DESCRIPTION OF THE DRAWINGS

Some embodiments of the present invention are illustrated as an example and are not limited by the figures of the accompanying drawings, in which like references may indicate similar elements and in which:

FIG. 1 depicts one example of a configuration of an electric motor according to various embodiments of the present invention.

FIG. 2 illustrates one example of mechanism used for making electrical connections to a dc voltage source according to various embodiments described herein.

FIG. 3A shows a partially exploded view of one example concerning one configuration that utilizes roller mechanism for electrical connections to a voltage source according to various embodiments described herein.

FIG. 3B shows a perspective view of an example for facilitating mounting of a tire when motor is to be used as part of a motorized wheel according to various embodiments described herein.

FIG. 3C illustrates a partially explosive view of an example of optional second roller assembly according to various embodiments described herein.

FIG. 3D shows a partially explosive side view of an example of roller assemblies according to various embodiments described herein.

FIG. 4 depicts an example of just two roller assemblies needed to facilitate electrical connection to a voltage source according to various embodiments described herein. Windings or conductors are not explicitly shown here but they are the same as in earlier figures.

FIG. 5 shows an example of a ball bearing and a roller assembly for making electrical connection to a power source according to embodiments described herein.

### DETAILED DESCRIPTION OF THE INVENTION

The terminology used herein is for the purpose of describing particular embodiments only and is not limiting of the invention. As used herein, the term “and/or” includes any and all combinations of one or more of the associated listed items. As used herein, the singular forms “a,” an,” and “the” are intended to include the plural forms as well as the singular forms, unless the context clearly indicates otherwise. It will be further understood that the term “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

Disc or flat dc electric machines, apparatuses, and methods for producing these machines are discussed herein. In the following description, for purposes of explanation, numerous specific details are set forth in order to provide a thorough understanding of the present invention. It will be evident, however, to one skilled in the art that present invention may be practiced without these specific details.

The present disclosure is to be considerd as an exemplification of the invention, and is not intended to limit the invention to the specific embodiments illustrated by the figures or description below.

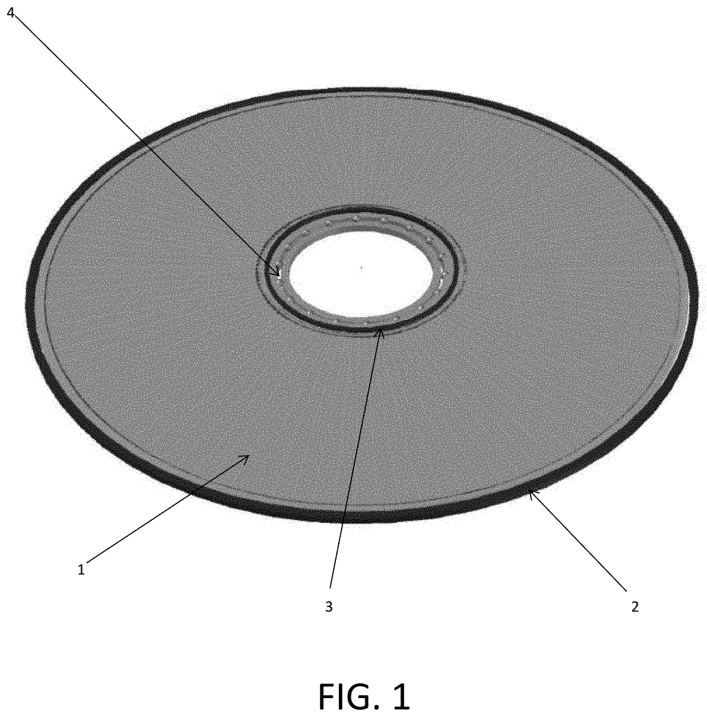

The present invention will now be described by referencing the appended figures representing preferred embodiments. FIG. 1 depicts one possible configuration. In this embodiment, the insulating coating of the electrical strips or windings 1 around the outer rim of the disc would be removed and may be encapsulated by a metallic ring 2 covering the bared portion of the electrical windings or strips according to various embodiments of the present invention. Same is done at the inner rim 3. One terminal of the battery may be connected to the conventional brush assembly pressed against the outer metallic covering 2 and the other terminal to the brush assembly pressed against the metallic cover 3 around the inner rim. However, the brush assembly for the central part of the bared windings may be pressed against the side portion of the covering and the inner side of the metallic covering may be pressed against the ball-bearing 4 snugly situated in the central part (near the center of the rotor). This would cause currents to flow through the radial strips 1 as desired. In the preferred embodiments of the present invention, currents flow in the same radial directions (either radially outward or inward) on both sides of rotor. In presence of a magnetic field perpendicular to the rotor, would cause this disc rotor to rotate about the axle passing through the inner hole of the annular disc. It is desirable to use the rotor “disc” that is made of a ferromagnetic material to increase the axial magnetic flux. So, the usage of ferromagnetic disc as the core of the rotor would provide large torque to the rotor that is especially suited for a motorized wheel in an electric vehicle (EV). It is desirable to make the axle pass through a ball bearing 4 fitted into the inner hole of the annular disc. For the metallic covering around the outer rim, it may be noted here that the brush assembly can also be pressed against the side of the metallic covering instead of that against its outer rim. We do not need a commutator for this type of DC machine. For this configuration, it is desirable to choose small ball bearing in the center to be made of an electrically non-conducting material. However, we can get rid of the brushes entirely by strapping a small power source on the rotor itself. For this case, the terminals of the power source are directly connected to the two ends of the conductors. Here, it would be convenient to turn the power on or off using a remote. It should be noted here that it is not necessary to mount electrical conductors on a physical disc; we can utilize thick conductors forming spokes of a wheel with circular rims at both ends of these spokes. By making electrical connection of the two terminal of the battery to these two rims in presence of an axial magnetic field, the wheel would start rotating about the axle. This rotor structure would offer an advantage if we choose to have a multi-rotor system wherein several rotors are mounted parallel to each other in presence of an axial magnetic field. The spoked wheel is made of electrically conductive material. The spoked wheel may be made of an electrically conductive ferromagnetic material. The electrical connection to the battery can be made through electrical contact assemblies, regular or roller type detailed later on.

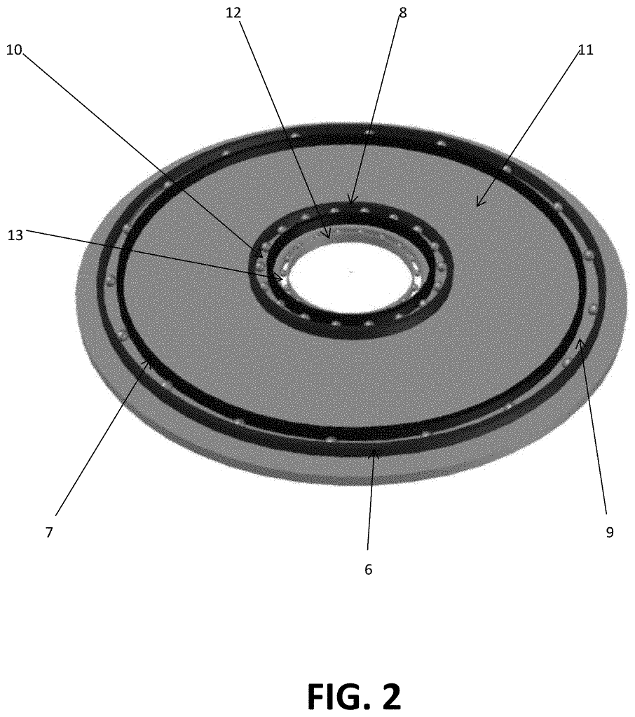

One conventional brush described above slides against the metallic cover around the portions of the strips or windings that go over the rim. However, the electrical contact assembly shown in FIG. 2 causes metallic ring 7 along with the disc rotor 11 to roll against the stationary metallic ring 6 near the rim, thereby, eliminating wear and tear associated with a conventional brush. In this configuration, the roller assemblies 9 and 10 are used for making electrical contacts at both bared ends of the radial strips (not shown explicitly in this figure but are the same as those in FIG. 1). Electrical terminals of the battery may be connected to the stationary (red) parts 6 and 8 of the two ball bearing type of metallic structures 9 and 10. As before, when a voltage is applied across the two terminals in presence of a magnetic field perpendicular to the surface of the annular disc 11, the disc would rotate about the axle passing through the hole in the annular disc. The axle snugly pressed against innermost ring 12 of the smallest central ball-bearing 13 remains stationary.

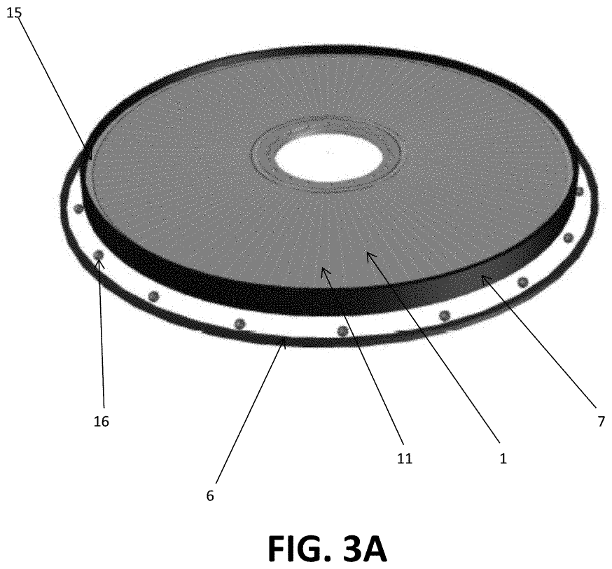

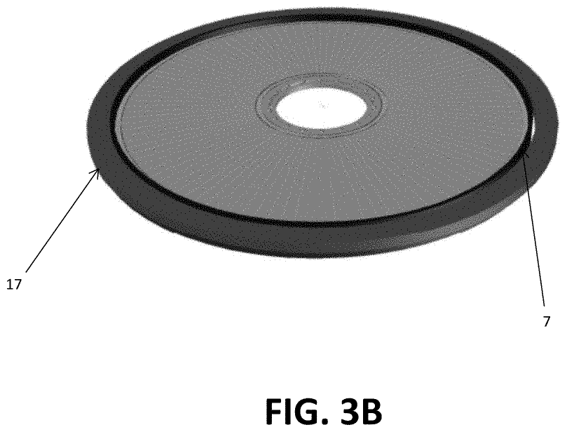

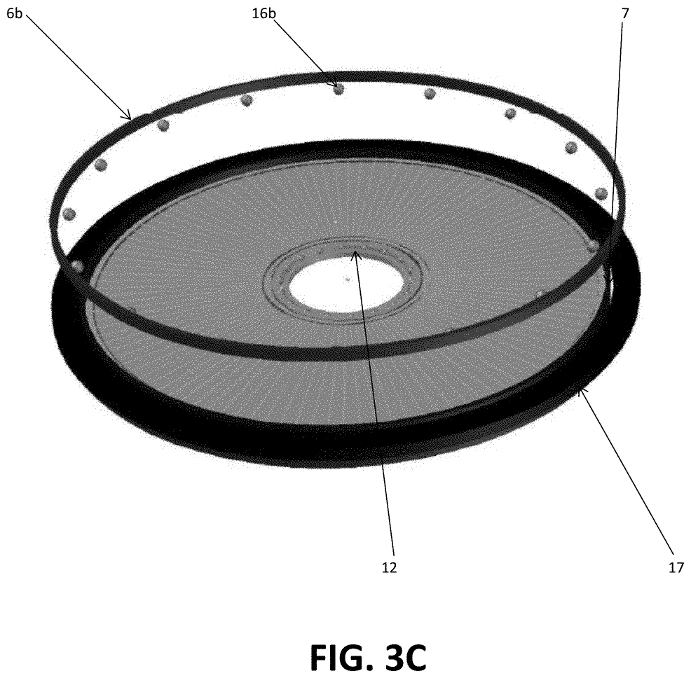

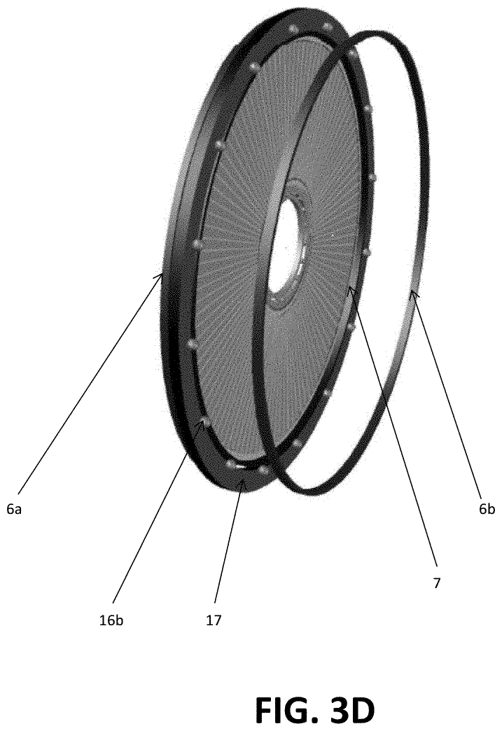

To understand the concept or mechanism of roller assemblies, let us look at FIG. 3A which illustrates a partially exploded view. An electrically conducting metallic ring 7 is fastened to the bared portion of the windings at the electrically conductive rim 15 of the disc rotor 11. The figure also shows a metallic ring 6 along with metallic balls 16 that would be pressed against the lower portion of the wider metallic ring 7 facilitating a ball bearing type of action. Next, an annular disc 17 (FIG. 3B) is fastened to the central portion of the wider ring 7 above the just described ball bearing type of structure. This annular disc 17 is shown in dark metallic color in FIG. 3B. This annular disc can be used to mount a tire on it which would be useful as a motorized wheel. FIG. 3C shows a partially exploded view of another ball bearing type of structure which can be mounted against the blue metallic ring 7 just above the dark annular disc 17. So now we have two ball bearing type of mechanisms on each side of this dark annular disc 17. This concept is also illustrated in FIG. 3D which shows partially exploded side view of the roller assemblies mounted on the disc rotor. Here one of the metallic rings 6b is shown separately even though the functional assembly would require it to be in physical contact with the metallic balls 16b. It should be noted here that even though in these figures we have shown two ball bearings on the two sides of the rotor, in reality, we can make the electrical connection to a battery with just either one of these two ball bearings.

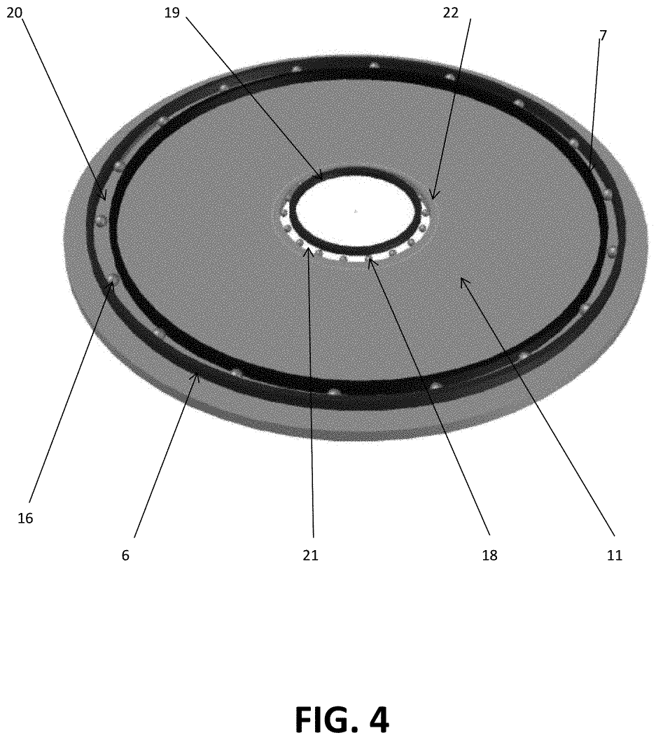

In another configuration, as shown in FIG. 4, the electrical contacts to battery terminals may be made through two electrically conductive ball bearings 20 and 21. One large ball bearing snugly fits on to the outer metallic rim 7 over the rotor covering the bared portions of the radial electrical conductors on the outer rim and the other smaller ball bearing 21 snugly fits inside the inner hole and is in electrical contact with the other bared portions of electrical windings passing through the inner hole of the rotor. This is shown in FIG. 4. Note that we have not explicitly shown the electrical windings or strips in this figure but that part is the same as that in earlier figures. The bigger ball bearing 20 hugging the outer rim has its outer ring 6 fixed and the inner ring 7 movable to allow annular disc rotor the freedom to rotate. However, for the smaller ball bearing the order is reversed, i.e. its outer ring 22 is mobile whereas its inner ring 19 is fixed. Similar to ball bearing 20, the inner ball bearing 21 comprises the metallic rings 19 and 22 that are in electrical contact with the electrically conductive balls 18. The two ball bearings are in electrical contacts with the two sets of bared ends of the radial conductors. This would allow the two terminals of the battery to be connected to the stationary outer electrically conductive ring 6 of the large ball bearing 20 and the stationary electrically conductive axle of rotation that is in electrical contact with the electrically conductive ring 19. Depending on the requirements, outer (farther away from the smaller ball-bearing) portions of the axle may be made of a non-conducting material. So, here the outer non-conducting parts of the axle are joined, using suitable fastener, to the middle conducting part of the axle. Thus, this would have only the electrically conducting middle part of the axle in electrical contact with the electrical windings passing through the inner hole of the annular disc rotor 11. Therefore, a terminal of the battery can readily be connected to the stationary conducting middle part of the axle through a suitable post on this part of the axle. As before, if a voltage is applied across the two battery terminals in presence of a magnetic field perpendicular to the annular disc rotor 11, the disc rotor would start rotating. It should be noted here that it is not necessary for axle to make the electrical connection because a battery terminal can be directly connected to the stationary part 19 of the inner and smaller ball bearing 21 in the central region of the rotor through a post provided at stationary part 19 of this ball bearing 21. This post is not explicitly shown in the figure. Usually this post will be attached to this part of the bearing on its side.

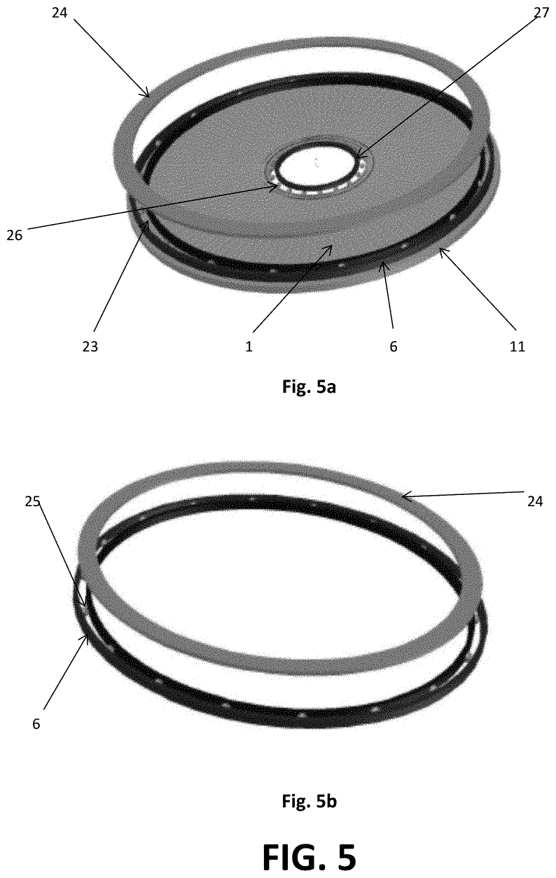

In this configuration, as shown in FIG. 5A, we replace the outer ball-bearing with the roller assembly 23 pressed against the bared windings/strips near the outer rim but on a side of the rotor 11. The partially exploded view, in which the wall covering 24, shown separately just above the ball bearing type of structure, is illustrated in this figure. Such an exploded view of the roller assembly alone is shown in FIG. 5B. It is essentially a ball bearing with one side open or exposed. The exposed side of this modified ball bearing is in electrical contact with the bared portion of the windings 1 in this outer region of the rotor 11. This electrical contact is made through the electrically conducting balls 25 of the electrically conducting ball bearing. Again, this is shown in FIG. 5A wherein the balls are in contact with the bared windings 1 in this outer region. The electrically conductive washer or annular disc 24 is in electrical contact with the electrically conductive balls 25. So, this rolling assembly acts as a thrust bearing. So, one battery terminal can be connected to washer 24 through a post on this washer (not shown in FIG. 5). A ball bearing 26 can be used to facilitate connection of the other terminal of the battery. A post attached to the stationary wall 27 can be used for this purpose. This post is not explicitly shown in this figure. This small ball bearing makes electrical contact to the bared windings or strips near the central part of the rotor 11. Since the roller assembly is making contacts on the side of the rotor, the outer rim is free to make contact with other surfaces such as a tire. Thus, electric motor can be built into a tired automobile wheel. The same is true of the configurations described in [00021] (FIGS. 2) and [00023] (FIG. 4). These configurations for electrical contacts allow the flexibility of distributed motor system for an electric vehicle (EV) which is easy to implement also because of the disc shape for the motor. Rear wheel, front wheel and all wheel drives are easily implemented here. A controller can easily switch among all these types of drives. In addition, by implementing a mechanism whereby the motorized wheel can be rotated about a vertical axis passing through the center of the wheel, we would have the flexibility of freely rotating wheels by 360 degrees which, for example, eliminates the need for complex parallel parking. A controller is needed here to synchronize orientation of the motorized wheels according to the need of the driver. It is possible to replace the present complex mechanical assembly for the rotation of the wheels in a vehicle by a much simpler mechanism that implements only the rotation of the wheel about a vertical axis. The appropriate steering can be achieved by electronically synchronizing the rotation of the wheels using a controller implementing appropriate algorithm suited for various steering requirements of a driver. So, as a driver rotates the steering wheel, the angle of rotation is inputted to a port of the microcontroller. Then the microcontroller processes this signal and outputs through its ports the appropriate signals (or coded instructions) to the appropriate wheels causing them to rotate about their vertical axes in an appropriate synchronized fashion to achieve the desired result. For most of the operations, rotation of only the front wheels would be needed.

It may be noted that, in practice, terminals of the battery are not connected to the posts mentioned above directly but rather through a current-limiting resistor or device.

It should be noted that a functional motor action can be realized by simply pressing the semi ball bearing type of structure consisting of a metallic ring 6 and metallic balls 16 against the metallic cover 7 over the electrically conductive rim encapsulating the electrical conductors 1. This is shown in FIG. 3A. Of course, the partially explosive view in this figure does not show an explicit contact of the semi ball bearing structure with the metallic cover around the bared portion of the windings on the rim of the rotor. Here, one of the terminals of the battery is connected to the stationary ball bearing through a post on ring 6 (the post not explicitly shown in this figure). This would allow current to flow through the radial windings or strips1 and in presence of a magnetic field perpendicular to the rotor surface, it would start rotating about an axle passing through the central hole in the rotor. The other terminal of the battery can be connected to the bared portion of the windings near the center by any of the earlier means discussed above.

In another preferred embodiment of the invention, the axle is fastened to the rotor through the central hole in annular rotor disc. The axle is made to pass through two ball or roller bearings near the two ends of the axle. This would facilitate rotation of the axle along with the rotor with the two bearings housed in the frame of the machine. For its operation as a motor, one terminal of the power source may be connected to the electrically conducting axle through a brush. The electrically conductive axle is made to be in electrical contact with the radial conductors passing through the central hole. It should be noted herein that only the central or the middle part (passing through the central hole) of the axle would necessarily need to be electrically conductive so as to facilitate electrical connection of one terminal of the power source through a brush that is in contact with this the electrically conductive middle part of the axle. Of course, as detailed earlier, a brush can be replaced with an electrically conductive bearing.

In another preferred embodiment of the invention, we can use a split axle with two electrically conductive parts insulated from each other through usage of a non-conductive middle part. The two ends of the conductors on the rotor make electrical contacts with the electrically conductive parts of the axle. If we choose to have a stationary axle then we can make one electrically conductive part of the axle to pass through the small central electrically conductive ball bearing that is already in electrical contact with the inner (central) ends of the conductors. The electrical contact of the other electrically conductive part of the axle can be implemented by running a thick wire from the outer rim of the rotor initially parallel to the axle and then dropping vertically down to a brush that would facilitate electrical connection to this part of the axle to the outer electrically conductive rim of the rotor. Of course, this outer rim is already making an electric connection to the conductors on the rotor. This brush may be in the form of another electrically conductive ball bearing through which this part of the axle passes. As detailed above, an electrical connection of the thick wire to the ball bearing can be made through a post on the outer ring of the ball bearing. If we choose to have axle rotate along with the rotor, then the thick wire can be connected directly to this conductive part of the axle. For this case the central part of the conductors are already in electrical contact with the other electrically conductive part of the axle. The terminals of the power source can make electrical contact with the two electrically conductive parts of the axle through brushes which may be of the regular or the rolling type. So, once again, the electrical contacts of the two terminals of the power source to the two ends of the conductors on the rotor are mad through the two conductive parts of the axle.

Various examples of mechanisms or configurations for making electrical contacts with the bared parts of the windings or strips have been described above. It should be noted here that any combinations or permutations of these mechanisms can be employed for a disc motor to make it operational. The choice would depend on the application of the disc motor. The two terminals of the battery can be connected to the two bared portions of the conductors through any combination or permutation of the various mechanisms described above.

So far various designs of the rotor have been exemplified. This rotor is subjected to an axial magnetic flux. This axial magnetic flux can be generated by a stator made up of either a powerful permanent disc magnet or an electromagnet. We can choose to use either an annular disc magnet or have a composite annular disc magnet made up of several trapezoidal magnets distributed all around the periphery of the disc. It may be desirable to use two sets of these stators, one on each side of the rotor.

However, we can do role reversal. We can keep the rotor stationary and allow the stator to rotate. The simplest and the preferred candidate for the new stator would be the one illustrated in FIG. 1. By applying a suitable voltage across the two rings 2 and 3, we can cause the annular magnetic disk (the original stator) to rotate. Here, of course, we are keeping the disk in FIG. 1 stationary and are allowing the original stator to rotate. So, we no longer need the ball bearing shown in FIG. 1 and, in fact, use this ball bearing on the original stator (annular magnetic disk) to facilitate its rotation. If we were to choose the original electromagnet as a rotator, then the electrical connection for it can be implemented by using any one of the mechanisms discussed above within the context of the original rotator, including having the small power source resident on this new rotor (originally the stator) itself. In another embodiment of this configuration, we may employ a second stator comprising the radial conductors on the other side of the rotor which consists of the magnets distributed near its periphery. This second stator on the other side of the rotor would supply additional torque to the rotor. If we use this motor, as a motorized wheel of an EV, then this second stator can also be used to apply brakes by reversing the current carried by the conductors on this stator. Of course, while applying brakes, the currents in the conductors of the first stator must be turned off for efficient braking.

We can even combine the original stator with the original rotator by simply wrapping a coil circumferentially around the rotator disc. The axial magnetic flux can be generated by passing a current through this coil wrapped around the disc rotator. Of course, the coil around the rotor must not be physically connected to the rotor. These configurations can be quite useful for a PCB or micro motor.

Rotor and stator both can be allowed to rotate freely. The two would exert equal and opposite torques on each other. The back emf would try to limit the rotational speeds of the two.

If battery pack is disconnected from rotor, and any of the rotors described herein is rotated by any means then these machines may be utilized as generators producing voltage across the conductors.

For an EV using the motorized wheels, described herein, it is quite easy to implement frictionless braking system. So, brakes can be applied by simply cutting off power to the conductors on the rotor. As the EV slows down power is being transferred back to the power system onboard through conversion of mechanical energy back into electrical energy. For a faster or better controlled braking, we can utilize an auxiliary power source which would allow a current to pass through the electrical conductors in the reverse direction, thereby effecting an additional torque to slow down the EV. A controller is needed here to achieve the desired results.

What is claimed is:

1. An axial flux flat dc electric machine comprising:
radial electrical conductors carrying currents flowing in the same directions, (radially inward or outward) on both sides of an annular rotor disc which may be made of ferromagnetic or non-ferromagnetic material and electrically insulated from the radial conductors;
said radial conductors may be implemented as spokes of electrically conductive ferromagnetic or non-ferromagnetic wheel, which would be especially convenient for a stacked multi-rotor electrical machine;
a stator, in close proximity to said rotor that would provide axial flux, may be a disc or annular disc permanent magnet or electromagnet which may be on one or both sides of said rotor;
a relatively low voltage power source connected to the two bared ends of said radial conductors of said rotor by using brushes requiring no commutation;
said power source may reside on or off said rotor and if it resides on said rotor then said terminals of said power source can make direct electrical connection to the two ends of said radial conductors thereby eliminating the need for a brush;
a ball bearing, located in the center, facilitating rotation of said rotor about a shaft passing through it.

2. An axial flux flat dc electric machine comprising:
an axial flux flat dc electric machine, as claimed in claim 1 with brushes replaced by roller type of mechanism to facilitate electrical connection of said radial conductors to said power source that comprises:
an outer ball bearing with outer ring being stationary with one terminal of said power source connected to it, and the inner ring being physically connected to said rotor;
an inner ball bearing in the central region of said rotor with outer ring kept stationary making an electrical connection to other terminal of said power source, and the inner ring physically connected to said rotor.

3. A tired motorized wheel comprising:
flat electric dc motor, as claimed in claim 2, but with any of two types of said “brushes” for making electrical connection to one of the terminals of said power source to the inner ends of said radial conductors;
said outer ball bearing, as claimed in claim 2, may be mounted on either side of said rotor;
a tire mounted on the outer periphery of said rotor.

4. An axial flux flat dc electric machine comprising:
axial flux flat dc electric motor, as claimed in claim 3, but without said brushes being utilized at the inner or central part of said radial conductors;
said outer ball bearing to which one terminal of said power source is connected through said stationary outer ring may be replaced with a thrust bearing;
an axle or shaft passing through said central ball bearing with an electrically conductive part of shaft in electrical contact with the inner metallic ring of said central ball bearing;
one terminal of said power source makes electrical contact with said stationary shaft which in turn is in electrical contact with inner ends of said radial conductors through electrically conductive said inner ball bearing;
alternatively, an electrically conductive axle or shaft may be physically connected to said radial conductors and make electrical contact to them at the central hole of said rotor and be made to pass through two electrically conductive ball bearings at its two ends facilitating electrical connection of one terminal of said power source to stationary outer ring of one of said two ball bearings situated at two ends of said shaft;
said electrical flat dc electrical motor can optionally be turned into a motorized wheel by mounting a tire on the outer periphery of said rotor;
said flat dc electric motors may have role reversal between said rotors and said stators;
said flat dc electric machines are readily implemented as flat micro machines at the chip level.

5. An Electric Vehicle (EV) whose drive system comprises:
said motorized wheels allowing for all-wheel drive system;
said motorized wheels that can be turned in a synchronized manner using a drive-by-wire steering system that utilizes a programmed controller thereby allowing complete flexibility including lateral parking that would eliminate the need for a rather complex parallel parking;
frictionless braking system, by reversing currents in said radial conductors of said motorized wheels by either reversing polarity of said power source or utilizing a second power source that would force said radial currents in opposite directions allowing electric power to be stored as said motorized wheels slow down that may require usage of a capacitor especially for the former option.
